(19) United States
(12) Patent Application Publication
(10) Pub. No.: US 2002/0077884 A1
(43) Pub. Date: Jun. 20, 2002

(54) Online method and system for providing learning solutions for the elimination of functional competency gaps

(76) Inventor: Edward Alun Sketch, Ann Arbor, MI (US)

Correspondence Address: BROOKS & KUSHMAN P.C./FGTI, 1000 TOWN CENTER, 22ND FLOOR, SOUTHFIELD, MI, 48098, US

(21) Appl. No.: 09/681,784

(22) Filed: Jun. 5, 2001

Related U.S. Application Data
(60) Provisional application No. 60/256,854, filed on Dec. 19, 2000.

(51) Int. Cl. G06F 17/60

(52) U.S. Cl. 705/12

(57) ABSTRACT

A method and online system for interactively assessing functional competency with respect to an employment function and providing a variety of learning solutions for eliminating gaps between the assessed level of functional competency and a level of functional competency required for the employment function. The learning solutions are provided in a learning format most compatible with the preferred method of learning. Feedback assesses the effectiveness of learning solutions, facilitates their improvement, and identifies organizational roadblocks to their implementation in the business environment. Users may assess and increase their functional competency with respect to current or desired employment functions. Additionally, a database of employee functional competencies is populated for mining by administrative personnel for decisions related to employment advancement, employee team selection and hiring objectives.

### CROSS REFERENCE TO RELATED APPLICATIONS

This application claims the benefit of U.S. provisional application Serial No. 60/256,854, filed Dec. 19, 2000.

### BACKGROUND OF INVENTION

This invention relates generally to the field of training and education and, more particularly, to an online method and system for providing learning solutions for the elimination of functional competency gaps.

Training organizations are constantly struggling in the ever-changing learning landscape to become more efficient and accountable for return on investment. This struggle is the result of investors wanting larger monetary returns for a smaller investment of capital. The resulting “pay for performance” ideology has placed a premium on acquiring a diverse set of competencies while de-emphasizing loyalty and job security. The real challenge facing training organizations, therefore, is not return on investment, but rather training employees with respect to an ever-increasing set of competencies in progressively more complex environments (where employees are not as loyal as in the past). Where once training focused on relatively straightforward procedures, employees are now empowered to make decisions, solve problems, and adapt to situations across all levels within an organization.

Compounding the issue is the increase in job complexity. As a result, the amount of information necessary to understand the relevant job competencies has also increased. Historically, training organizations have been concerned with structured content that is controlled using widely accepted instructional systems and methodologies. In other words, learning was structured around clear objectives related to content deemed appropriate to a given job function. The rapid rate of change in the core competencies of most jobs today, however, has limited the ability of training organizations with restricted resources and budgets to react quickly enough to meet the learning needs of its employees. Consequently, employees have begun to turn to both the Internet and corporate intranet as repositories of learning information (e.g., “Lessons Learned” websites, knowledge portals and journal websites).

Although many learning leaders may suggest that the content on these sites is inappropriate for training due to its unstructured and uncontrolled nature, its place in the learning landscape cannot be ignored. The International Data Corporation has predicted that the daily content on corporate intranets will rise from just over 200 terabytes of information per day to almost 1200 terabytes in the next five years. Undeniably, a significant percentage of this unstructured information is business critical knowledge that, if harnessed, would provide a powerful source of learning to employees. Current learning theories offer few, if any, suggestions for tapping such a rich resource of uncontrolled content while simultaneously providing controlled objective-based training. Most learning theories are still based on traditional behaviorism principles limiting the ability to map the complex cognitive processes necessary to utilize the various modes of information.

Unfortunately, as the competencies associated with jobs become more complicated and the time for training decreases due to the “needs of the business”, the opportunity for individuals to evaluate training resources decreases. For novice learners, this may be a moot point because they lack the skills and knowledge to be able to navigate all of the available learning resources. On the other hand, expert learners are likely to be overwhelmed by the amount of information available in both controlled and uncontrolled environments. In both situations, neither type of employee fully realizes his or her learning potential due to an inability to create a complete personal development plan tailored uniquely to that employee.

With these limitations recognized, the goal of any innovative solution should be to automate the process of creating a custom learning environment for each individual employee. The learning environment should dynamically account for all relevant information, both controlled and uncontrolled, that the business drivers (i.e., business unit management) deem important to acquiring job-specific competencies and overall organizational success.

Previous systems that have related competencies to learning content have either programmed the relationships into software or used a search engine to identify the content via word strings. The shortcomings of such systems include the cost of creating and updating the links and an inability of the system to dynamically modify itself based on user needs. Using search engines to retrieve content is limited because they frequently identify relevant documents based on key words rather than actual concepts presented in the documents. In addition, previous systems lack the intelligence to learn from or adapt to the user's behavior. In other words, the learning environment must be capable of incorporating new information, adapting existing relationships of content, and focusing on the interest of the users.

### SUMMARY OF INVENTION

One object of the present invention is to provide a method and online system for interactively assessing an employee's level of functional competency with respect to his or her employment function and providing the employee with a variety of learning solutions (e.g., classroom training, software training, online training, on-the-job training, etc.) for eliminating gaps between the employee's current level of functional competency and the level of functional competency required for the employee's employment function. In accord with a preferred embodiment of the present invention, the learning solutions are provided to an employee in a learning format most compatible with the employee's preferred method of learning.

Another object of the present invention is to facilitate employee feedback for assessing and increasing the effectiveness of the learning solutions. Additionally, the present invention facilitates the identification and elimination of organizational roadblocks which impede or undermine the implementation of the learning solutions in the business environment.

Yet another object of the present invention is to assess an employee's competency level with respect to an employment function the employee aspires to, and provide a variety of learning solutions for eliminating gaps between the employee's current level of functional competency and the level of competency required for the employment function the employee aspires to.

Another object of the present invention is to compile a database of employee competency level information for mining by administrative personnel. This aspect of the present invention facilitates personnel decisions including employment advancement, employee team selection and hiring objectives.

To meet these objects and features, as well as additional objects and features of the present invention, a method for reducing a functional competency gap includes defining an employment function and preferred method of learning, assessing functional competency based on the employment function via an online self-assessment, identifying at least one gap between the assessed functional competency and a predefined competency required for the employment function, and identifying at least one learning solution for reducing the at least one competency gap based on the preferred method of learning.

The present invention provides a number of advantages. For example, employees are provided with an interactive system through which they may independently assess their level of functional competency and be provided with learning solutions for improving that level in a format that is best-tailored to the employee's preformed method of learning. In addition, corporate or organizational administration is provided with a means by which to govern and assess employee competency levels, as well as identify and eliminate organizational road blocks to effective implementation of learning solutions.

The above objects, features and advantages of the present invention, as well as additional objects, features and advantages will be readily apparent from the following detailed description of the preferred embodiments when taken in connection with the accompanying drawings.

### BRIEF DESCRIPTION OF DRAWINGS

FIG. 1 is a block flow diagram illustrating a preferred method for implementing the present invention;

FIG. 2 is a web page containing an example interactive competency self-assessment in accord with the present invention;

FIG. 3 is a web page containing an example personal development plan in accord with the present invention;

FIG. 4 illustrates a preferred system for implementing the present invention; and

FIG. 5 illustrates an example online course evaluation form in accord with the present invention.

### DETAILED DESCRIPTION

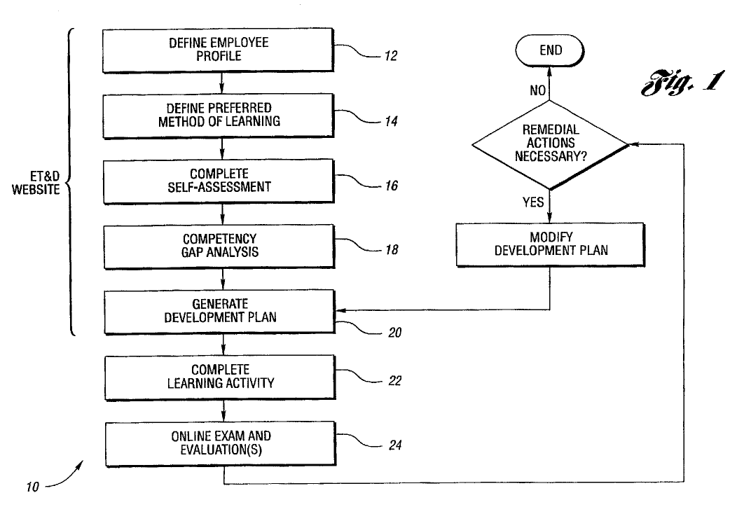

In accord with one embodiment of the present invention, a method is provided for assessing and eliminating employee functional competency gaps. FIG. 1 is a block flow diagram illustrating an overview of a business method 10 for implementing the present invention. As described in block 12, an employee accesses an Electronic Training and Development (ET&D) website and inputs his or her employee profile information. Employee profile information includes but is not limited to the employee's demographic information (e.g., name, address, telephone number, e-mail address, etc.), employment function, salary, hiring information and online resume.

Next, the employee defines his or her preferred method of learning as described in block 14. Methods of learning include, but are not limited to, traditional classroom training, online training, distance learning, video streaming, pic-tel, on-the-job support, action learning, self-training, discussion groups, chat and e-mail.

As described in block 16, the employee next completes an interactive self-assessment of the employee's current competency level(s) with respect to his or her leadership qualities and/or skills particular to the employee's current employment function. Alternately, the employee utilizes the self-assessment as a career planning tool to assess his or her current competency level for an employment function to which the employee aspires but in which the employee is not currently employed.

The leadership aspect of the self-assessment comprises an interactive evaluation of the employee's current competency level with respect to qualities including but not limited to integrity, courage, durability, drive for results, teamwork, desire to serve, people development, communication, quality methods, systematic thinking and innovation. Content for the interactive leadership skills self-assessment is provided by corporate management and is based on a corporate vision of the leadership qualities expected of employees by functional area and/or job group.

The job-specific aspect of the self-assessment comprises an evaluation of the employee's current competency level with respect to tasks or skills unique to his or her employment function. Content for the interactive job-specific skills self-assessments is provided by business unit management supervising or responsible for each employment function.

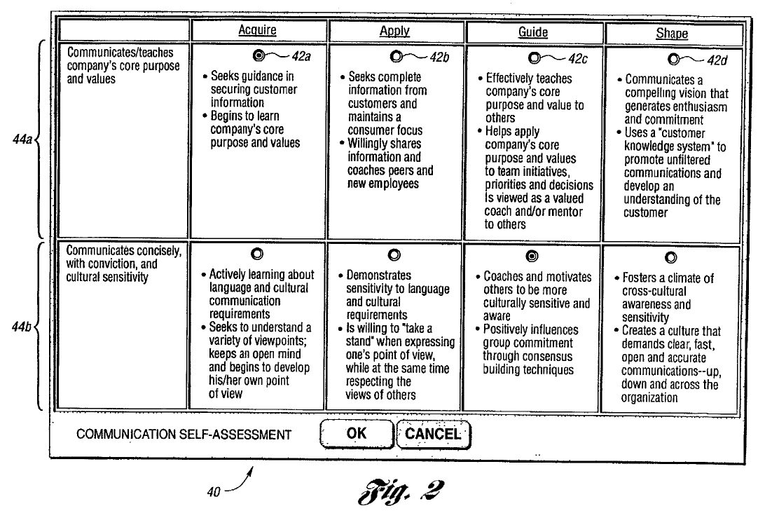

FIG. 2 is a web page 40 containing an example self-assessment for the “Communication” leadership quality. To complete the self-assessment, the employee selects a radio button 42a-42d corresponding to the competency level (i.e., “Acquire”, “Apply”, “Guide”, etc.) for each aspect 44a-44b of the self-assessment that best matches the employee's current competency level.

Preferably, a dialog is created between the employee and his or her supervisor or manager to reach an agreement with respect to the employee's current level(s) prior to submitting a completed self-assessment. Notably, however, employees who submit a completed self-assessment can thereafter access and update their previous self-assessment responses.

Preferably, third party online assessments of the employee's current competency levels are completed in addition to the employee self-assessment. Third party online assessments include but are not limited to assessments completed by the employee's supervisor(s) and subordinates.

Referring again to FIG. 1, an employee competency gap analysis is conducted upon submission of the completed employee assessment(s), as described in block 18. The competency gap analysis comprises an automated comparison between the employee assessment data and predefined leadership and job-specific competency requirements by employment function. Required competency levels for employee leadership skills are primarily defined online by organizational or corporate management. Required competency levels for job-specific skills are primarily defined online by business unit management supervising or responsible for the performance of each employment function.

As a result of the competency gap analysis, any discrepancies (i.e., “gaps”) between the employee's current leadership and job specific competency levels and the corresponding required competency levels are automatically identified.

As described in block 20, an online employee development plan is generated based on the outcome of the competency gap analysis. The online employee development plan comprises a listing of all competency gaps identified during the competency gap analysis and, for each competency gap, at least one link to a learning solution that has been preselected as best-in-class content for educating the employee in a manner that tends to reduce or eliminate the corresponding competency gap. To automatically locate the most appropriate learning solution(s) to include within the employee's online development plan, a dynamic search engine queries a database of all available learning solutions for at least one best-in-class learning solution that has been preselected for reducing or eliminating the particular competing gap and best matches the employee's preferred method of learning.

In accord with a preferred embodiment of the present invention, learning solutions include but are not limited to the following:

Traditional classroom training—provides instructor-led curriculum in a training facility using presentation aids/equipment;

Online training—personal computer training with network connectivity that can be used for communications, online reference, test and assessments, and surveys, and to distribute computer-based training (CBT);

Distance learning—training methodology that may encompass a number of delivery vehicles such as CD-ROM, synchronous video, and satellite;

Synchronous video streaming—provides a video and audio learning solution capability via a laptop or LAN system;

Pic-Tel—provides a method of two-way video and audio (“Face-to-face” communication) over vast distances;

Collaborative hybrid—two or more learning solution formats combined;

Electronics Performance Support System (EPSS)—a broad range of computer-based initiatives designed to provide information, advice, and embedded training experiences while on the job;

Vendor (third party) training—supplier-provided training needed to meet corporate requirements, from new technology equipment and controllers to new soft skills and organizational development philosophies;

Custom corporate courses—designed and delivered by a particular corporation;

Real work integration—designed to integrate learning to real work via projects, tutorials and simulations;

Action learning—a hands-on learning solution usually coupled with one-on-one, one-on-few, or one-on-many coaching;

Self-study (informal training)—learning participants may need to purchase literature as the optimum learning solution to an identified training need;

Discussion group—an informal learning method that allows individuals with common interests to exchange/share ideas and experiences;

Threaded discussion group—often more formalized (i.e., individuals assigned, scheduled meetings, etc.) with a specific focus that is part of a larger goal;

Chat room—an online, real-time coaching or idea exchange learning method; and

E-mail—another coaching or information exchange option that is not real time.

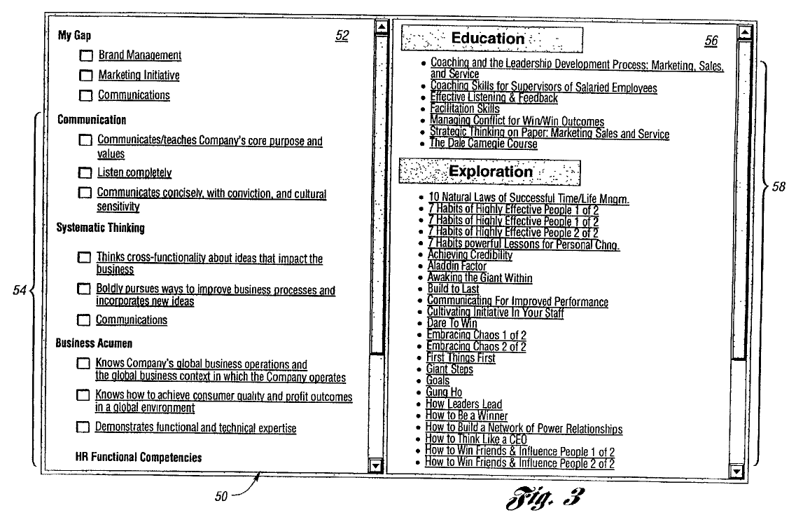

FIG. 3 illustrates a web page 50 containing an example online employee development plan in accord with the present invention. The example online employee development plan 50 comprises a first area 52 containing a listing 54 of each competency gap category and sub-category corresponding to the outcome of the employee's previously completed competency self-assessment(s). A second area 56 comprises a listing of hyperlinks to learning solutions for reducing or eliminating any competency gap selected in the first area. In one embodiment, each area corresponds to a frame of a web page. Those of ordinary skill in the art will recognize various other implementations to present related information and gather user input consistent with the invention as described.

In addition to the competency gap analysis, learning solutions can be identified and presented within an employee's personal development plan based on criteria including but not limited to the employee's job performance, functional or organizational needs, voluntary training, or in response to a keyword search of the learning solution database. If no learning solution presently exists for a particular competency gap or employee concern, an employee submits an online request for a new learning solution. New learning solution acquisition is discussed in more detail, infra.

Referring again to FIG. 1, block 22, an employee completes a selected learning solution activity to reduce or eliminate an identified competency gap. Prior to doing so, the employee selects a desired learning solution hyperlink within his or her online development plan, registers to receive the learning solution (online, telephone, fax, etc.), receives registration confirmation (via e-mail etc.) and schedules the selected training (i.e., instructor, date, time, location, etc.). Depending on the learning solution selected, the employee may receive pre-work assignments to be completed before participating in the learning activity (i.e., preliminary reading, forms, etc.).

After completing a particular learning activity, the employee evaluates the overall learning solution as described in block 24. Preferably, an online post-training evaluation or exam is given to an employee immediately after completing a learning activity to determine the extent to which knowledge has been transferred from the learning solution to the employee. As discussed in more detail infra, the post-training evaluation also supports follow-up including identifying learning solution improvement opportunities and recommending remedial learning solutions or activities. Preferably, assessment/exam results and any corresponding remediation suggestions or activities are documented within each employee's personal profile.

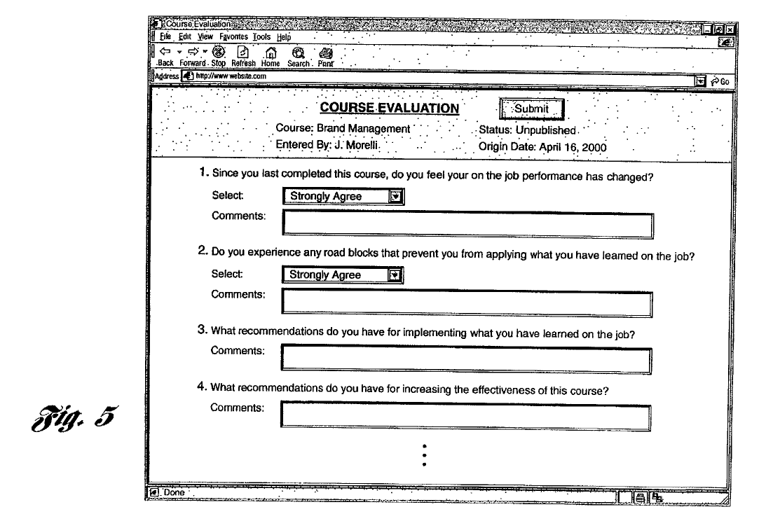

A delayed online evaluation is given to an employee approximately three to six months after the learning activity has been completed to survey the extent to which the acquired skills have been applied on the job and the extent to which anticipated business results have been achieved. FIG. 5 illustrates an example web page containing an online evaluation in accord with the present invention. Preferably, best practices for applying acquired skills and obtaining business results are collected and posted to a best practices web page (not shown) for employee review. As discussed in more detail, infra, any organizational development roadblocks to the application of acquired skills are identified and reported for subsequent analysis and elimination as described in block 24.

Preferably, employees having a newly-identified competency gap review previously-submitted online evaluations corresponding to the learning solutions included within their particular development plans. Employees may consider past evaluations and best practices when selecting, practicing or applying their learning solutions on the job.

Learning solutions are acquired in a plurality of manners including but not limited to purchasing rights to copyrighted online content (books, videos, recordings, etc.) generating solutions in-house and acquiring learning solutions via an online auction. The online auction format allows the online bidding of posted competency requirements by qualified and/or certified learning solution suppliers, collecting bids, accepting bids, generating purchase orders and confirmations, and ultimately completing the purchase process. Similarly, the online auction format can be utilized for the sale of acquired or in-house learning solutions to third party learning solution purchasers.

Yet another aspect of the present invention comprises a business consulting center for identifying and eliminating organization developmental roadblocks, making recommendations of possible changes to existing learning solutions based on learning solution evaluations, identifying the need for new learning solutions and linking training resources, products, services and consulting expertise to the needs of employees and third party learning solution customers. Preferably, all consultants participating in the business consulting center are certified within specific areas of expertise prior to their participation. Once certified, the consultants are preferably added to an online registry of certified business consultants by area of expertise. Additionally, the consulting center supports an online auction of consulting services for the purchase and sale of business consulting services.

In accord with another embodiment of the present invention, an online system is provided. The online system may be implemented utilizing programming languages and utilities including but not limited to hypertext mark-up language (HTML), dynamic hypertext mark-up language (DHTML), vector-based animation (e.g., Flash™) extensible mark-up language (XML), active server pages (ASP), virtual reality mark-up language (VRML), cascading style sheets (CSS), layering, server side includes (SSI), common gateway interfacing (CGI), C++ and Java.

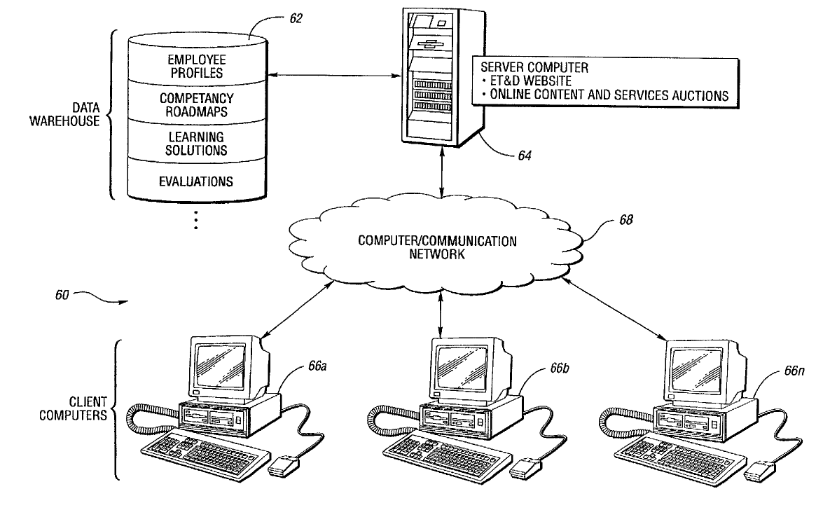

FIG. 4 illustrates an overview of a preferred online system 60 for implementing the present invention. The online system 60 comprises at least one server computer 62 operably connected to at least one database 64 and serving a plurality of client computers 66a-66n via a computer network 68 including but not limited to the Internet including the World Wide Web, a local or a wide area network (LAN/WAN).

In accord with a preferred embodiment of the present invention, the server computerhosts the Electronic Training and Development (ET&D) website described, supra, and is configured to operably serve a plurality of client users including but not limited to employees, business unit and corporate management, instructors, leadership and personal development centers, and human resources personnel. Additionally, the server computer 62 is configured to host an online auction for posting and bidding on the sale and purchase of learning solution content to and from learning solution suppliers and buyers. Preferably, access, content and interfaces provided to each client user are custom tailored to each client's respective system role.

A data warehouse 64 comprises a plurality of databases for archiving data collected in accord with the present invention. One aspect of the data warehouse comprises employee profile information. Employee profile information includes, but is not limited to, employee name, contact information, employment function, salary, hiring information, employment history, learning style preference, past skill assessments and gap analyses, the employee's personal development plan, learning solution evaluations, remedial actions, and an online resume.

Another aspect of the data warehouse comprises competency road maps. Competency road maps define the leadership and job-specific competency matrix for each functional area. Competency road maps define the structure and content of the employee self-assessments and subsequent competency gap analyses. The structure of the competency roadmap for each employment function is defined in an online format by corporate management and the business unit management responsible for each employment function.

Another aspect of the data warehouse comprises a central storage location for all online learning solution content. Online learning solution content includes, but is not limited to, digital audio and video data in a plurality of operable formats for downloading or streaming learning solution content to client end users.

Yet another aspect of the data warehouse comprises a database populated with the online learning solution evaluation responses and best practices feedback provided by employees after they have completed one or more learning activities.

In accord with a preferred embodiment of the present invention, information contained within the data warehouse 62 is mined in a plurality of productive manners. For example, post-training evaluations may be mined to identify trends in corporate transformation. Post-training evaluations may also indicate areas where learning solution improvement or development is necessary. The evaluations may identify opportunities for improving capabilities, functions and processes associated with corporate functions and processes as well as with existing and newly acquired learning solutions themselves. Additionally, the post-training evaluations may indicate problems with learning solution content, facilities, pre-work, instructors, coaches, facilitators and materials. Delayed evaluations may be mined to identify and eliminate organizational development roadblocks. Functional competency requirements and corresponding employee competency assessments may be mined or updated to ensure that the most recent and comprehensive company-wide competency requirements and the best-in-class learning solutions are provided. Learning solution instructors, coaches, facilitators, instructional systems designers and content developers may access the data warehouse to retrieve, reuse, modify and customize existing learning solutions to meet educational needs that may be independent of the learning solution delivery. A corporate recruiting department may mine the competency matrix to determine what skills will be required for future recruiting needs (i.e., what leadership and function-specific skills must the new recruits possess to be most valuable to the company or business unit). Employee profiles may be mined to identify employees best suited to perform a unique task or serve on a functional group. Human resources may mine employee profiles to identify an employee best suited for advancement or transfer to an existing or vacant position. Similarly, employee profiles may indicate to human resources that an employee is currently performing an employment function that is unreasonably dissimilar to the employee's demonstrated competencies (or lack thereof).

As such, the present invention provides a method and system for reducing functional competency gaps which allows employees to assess their level of functional competency within their employment function, provides employees with learning solutions for increasing their level of functional competency where the format of the learning solutions are tailored to the employee's preference and provides corporate or organizational administration with a means by which to govern and assess employee competency levels as well as identify and eliminate organizational road blocks to effective implementation of learning solutions.

While the best mode for carrying out the invention has been described in detail, those familiar with the art to which this invention relates will recognize various alternative designs and embodiments for practicing the invention as defined by the following claims.

1. A method for reducing a functional competency gap, the method comprising:
defining an employment function and preferred method of learning;
assessing functional competency based on the employment function via an online self-assessment;
identifying at least one gap between an assessed functional competency and a predefined competency required for the employment function; and
identifying at least one learning solution for reducing the at least one competency gap wherein the at least one learning solution is in accordance with the preferred method of learning.

2. The method of claim 1 wherein the at least one learning solution comprises classroom, software, online and on-the-job training learning activities.

3. The method of claim 1 additionally comprising completing a learning activity associated with the at least one learning solution.

4. The method of claim 3 additionally comprising evaluating the learning solution after completing the learning activity.

5. The method of claim 3 additionally comprising evaluating best practices for implementing the at least one learning solution within a business unit.

6. The method of claim 4 additionally comprising posting completed evaluations online for others to review.

7. The method of claim 5 additionally comprising identifying roadblocks to the implementation of the learning solution within a business unit.

8. The method of claim 3 additionally comprising completing an online examination after completing the learning solution to assess knowledge transfer during the learning activity.

9. The method of claim 4 additionally comprising mining evaluation data to identify and make learning solution improvements.

10. The method of claim 1 additionally comprising acquiring or selling learning solutions in an online auction format.

11. The method of claim 1 additionally comprising mining online assessment data to identify preferred functional competencies for new employees.

12. The method of claim 1 additionally comprising mining online assessment data to select current employees for a particular employment opportunity.

13. The method of claim 1 additionally comprising assessing functional competency for an employment function other than an employee's current employment function.

14. The method of claim 1 additionally comprising mining assessment data to select a group of employees having functional competencies necessary to perform a group-oriented task.

15. An online system for identifying at least one learning solution to reduce a functional competency gap, the system being configured to:
receive input defining an employment function and preferred method of learning;
present an interactive assessment of functional competency based on the employment function;
identify at least one gap between an assessed level of functional competency and a predefined level of competency required for the employment function; and
present output identifying at least one learning solution for reducing the at least one competency gap wherein the at least one learning solution is in accordance with the preferred method of learning.

16. The system of claim 15 additionally configured to receive input defining: (i) interactive assessment content; (ii) learning solution content; and (iii) competency level requirements for the employment function.

17. The online system of claim 15 additionally configured to host an online auction for the sale or purchase of learning solution content.

18. The online system of claim 15 additionally configured to present an interactive learning solution.

19. The online system of claim 17 additionally configured to facilitate mining employment function, competency assessment, competency gap, and evaluation data.

20. A system for reducing a functional competency gap, the system comprising:
a means for defining an employment function and preferred method of learning;
a means for assessing functional competency for the employment function;
a means for identifying at least one gap between a functional competency assessment and a predefined level of functional competency required for the employment function; and
a means for identifying at least one learning solution for reducing the at least one competency gap wherein the at least one learning solution is in accordance with the preferred method of learning.
